(19) United States
(12) Patent Application Publication
(10) Pub. No.: US 2023/0061706 A1
(43) Pub. Date: Mar. 2, 2023

(54) INFORMATION PROCESSING APPARATUS, INFORMATION PROCESSING METHOD, AND RECORDING MEDIUM

(71) Applicant: CANON KABUSHIKI KAISHA, Tokyo (JP)

(72) Inventor: Etsuya Takami, Kanagawa (JP)

(21) Appl. No.: 17/819,774

(22) Filed: Aug. 15, 2022

(30) Foreign Application Priority Data
Aug. 25, 2021 (JP) 2021-137083

(51) Int. Cl. H04N 5/232

(52) U.S. Cl. CPC H04N 5/23206; H04N 5/23245; H04N 5/23299

(57) ABSTRACT

An information processing apparatus sets sleep periods of devices in the vicinity of an imaging range based on, if any, a cyclical schedule of preset pan-tilt positions and zoom positions. The information processing apparatus then acquires information on the devices in the vicinity of the imaging range before target pan-tilt position and zoom position are reached, and provides the acquired information to a display device or the like after the target pan-tilt position and zoom position are reached.

### BACKGROUND

### Field of the Disclosure

The present disclosure relates to an information processing apparatus, an information processing method, and a recording medium.

### Description of the Related Art

There have been known imaging apparatuses that are capable of controlling IoT devices (hereinafter, simply referred to devices), some of which can control 100 or more devices. However, if such an imaging apparatus provides information on all the connected devices to the user, the user may become confused. Thus, it is necessary to select devices required by the user from among the connected devices.

In order to solve this issue, there has been known a method by which the devices to be notified to the user are limited to the devices seen in a video image and the information on the devices located in the vicinity of the imaging range of the imaging apparatus is acquired and provided to the user, based on the information on the imaging direction and imaging range of the imaging apparatus. Japanese Patent Application Laid-Open No. 2012-119971 discusses a monitoring video display apparatus that acquires imaging direction information from a camera, acquires positional information on a monitored object and additional information from an external system, associates the monitored object with the additional information based on the imaging direction information and the positional information, and displays the information superimposed on the video image.

In contrast, some devices have the capability of putting themselves into a sleep mode and stopping communication with external devices, thereby lowering power consumption. For example, in a case where the imaging apparatus acquires the information on the devices located in the vicinity of the imaging range based on the information on the imaging direction and the imaging range, the imaging apparatus cannot immediately acquire various types of information on the devices if the devices are in a sleep mode.

In the technique discussed in Japanese Patent Application Laid-Open No. 2012-119971, no consideration is given to the case where a device related to the monitored object is in a sleep mode and cannot accept an instruction from the imaging apparatus for information acquisition.

This may take much time for the device to return from the sleep mode and acquire the state of the device and various kinds of information, thereby causing a significant delay in providing the information to the user.

### SUMMARY

According to an embodiment of the present disclosure, an information processing apparatus communicating with an external device includes a first acquisition unit configured to acquire information on a change in an imaging range of an imaging unit, a control unit configured to perform a control to make a setting on a sleep mode of the external device that possibly falls within the imaging range due to the change in the imaging range, a second acquisition unit configured to acquire information on the external device, from the external device having returned from the sleep mode in accordance with the setting by the control unit, and an output unit configured to output the information acquired by the second acquisition unit.

Further features of the various embodiments will become apparent from the following description of exemplary embodiments with reference to the attached drawings.

### BRIEF DESCRIPTION OF THE DRAWINGS

FIG. 1 is a block diagram illustrating an example of an internal configuration of imaging apparatuses according to a first exemplary embodiment and a second exemplary embodiment.

FIG. 2 is a flowchart of an example of a processing procedure followed by the imaging apparatus according to the first exemplary embodiment.

FIG. 3 is a flowchart of an example of a processing procedure followed by the imaging apparatus according to the second exemplary embodiment.

FIG. 4 is a diagram illustrating an example of a cycling schedule of preset positions and sleep schedules of related devices according to the first exemplary embodiment.

### DESCRIPTION OF THE EMBODIMENTS

Hereinafter, exemplary embodiments will be described with reference to the drawings.

An imaging apparatus according to a first exemplary embodiment can be installed in various devices having a function of capturing images of a subject. Examples of the devices having the function of capturing images of a subject include network cameras, video cameras, still cameras, mobile phones having an imaging function, and personal digital assistants.

Described below is an exemplary embodiment relating to a control technique for an imaging apparatus having a communication mode under Z-Wave wireless communication protocol to acquire information on devices located in the vicinity of an imaging range on the basis of a pan-tilt position and a zoom position. The devices located in the vicinity of the imaging range refer to devices that are at least partially seen in the video image. However, some embodiments are not limited to the Z-Wave wireless communication protocol and there is no restriction on the communication mode.

Described in relation to the first exemplary embodiment is an example of setting and carrying a cyclical schedule of preset pan-tilt positions and zoom positions of the imaging apparatus 100. Also described is a control method for putting into a sleep mode the devices located in the vicinity of the imaging range at the target pan-tilt position and zoom position, and then returning the devices from the sleep mode, and acquiring the information on the devices.

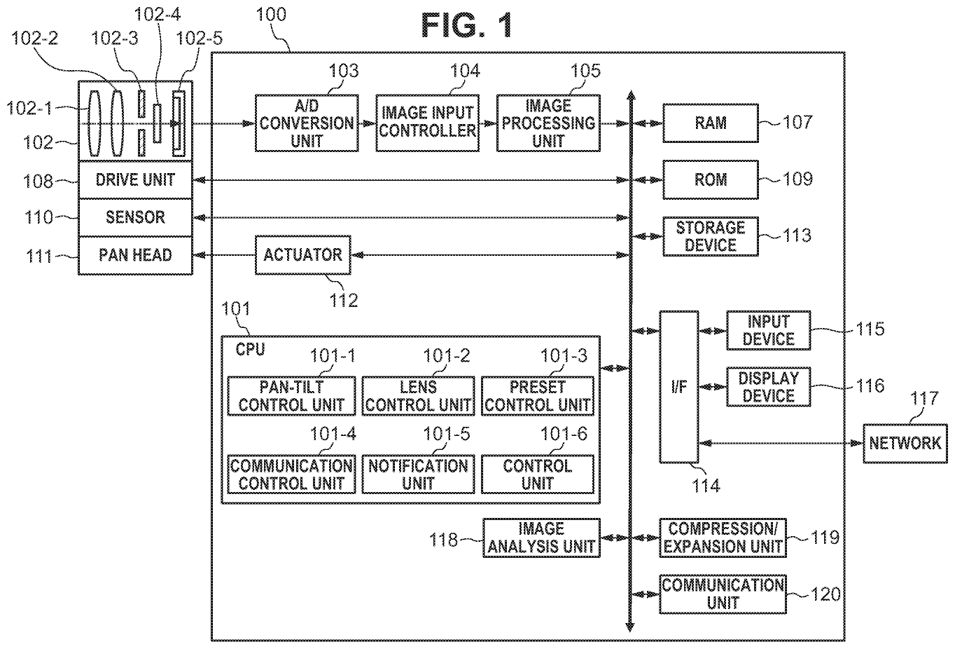

FIG. 1 is a block diagram illustrating an example of an internal configuration of the imaging apparatus 100 according to the present exemplary embodiment.

The imaging apparatus 100 according to the present exemplary embodiment includes a central processing unit (CPU) 101, an imaging unit 102, an analog to digital (A/D) conversion unit 103, an image input controller 104, an image processing unit 105, a random access memory (RAM) 107, a drive unit 108, a read only memory (ROM) 109, a sensor 110, and a pan head 111. The imaging apparatus 100 also includes an actuator 112, a storage device 113, an interface (I/F) 114, an input device 115, a display device 116, an image analysis unit 118, a compression/expansion unit 119, and a communication unit 120.

The CPU 101 is a central arithmetic processing unit. The CPU 101 includes functional components, that is, a pan-tilt control unit 101-1, a lens control unit 101-2, a preset control unit 101-3, a communication control unit 101-4, a notification unit 101-5, and a control unit 101-6.

The imaging unit 102 includes a zoom lens 102-1, a focus lens 102-2, an aperture 102-3, an infrared cut filter 102-4, and an imaging element 102-5 formed of an image sensor or the like.

The zoom lens 102-1 and the focus lens 102-2 are moved along an optical axis by the drive unit 108. The aperture 102-3 is driven by the drive unit 108 to adjust the amount of light to pass. The infrared cut filter 102-4 is driven by the drive unit 108 to operate.

The infrared cut filter 102-4 is inserted when sufficient illuminance can be obtained for a subject to be imaged, so that the imaging element 102-5 receives light not having infrared rays. The infrared cut filter 102-4 is removed when no sufficient illuminance can be obtained for a subject to be imaged, so that the imaging element 102-5 receives light having infrared rays. While the infrared cut filter 102-4 is removed, an infrared lamp may be turned on toward the subject to reinforce the visibility of the dark sections to secure the illuminance of infrared rays.

The drive unit 108 is controlled by the lens control unit 101-2 to drive the zoom lens 102-1, the focus lens 102-2, the aperture 102-3, and the infrared cut filter 102-4 in the imaging unit 102 as described above.

The sensor 110 includes one or more of an acceleration sensor, an angular velocity sensor, and a geomagnetic sensor. The sensor 110 detects an acceleration, an angular velocity, or a displacement of orientation of the imaging unit 102 at a predetermined sampling rate, and notifies these values to the CPU 101 via a bus 106.

The pan head 111 includes a pan drive unit and a tilt drive unit. The pan drive unit of the pan head 111 includes a bottom case and a turntable. The turntable rotates horizontally to cause the imaging unit 102 to pan. The pan drive unit of the pan head 111 according to the present exemplary embodiment can rotate horizontally from −175 degrees to +175 degrees. The tilt drive unit of the pan head 111 has a column and the imaging unit 102 provided on the turntable, and the imaging unit 102 rotates vertically. The tilt drive unit of the pan head 111 according to the present exemplary embodiment can rotate from horizontal zero degree to 90 degrees directly upward.

In this manner, the imaging unit 102 rotates horizontally and vertically via the actuator 112 to capture images in different imaging directions.

The actuator 112 is controlled by the pan-tilt control unit 101-1.

The imaging element 102-5 photoelectrically converts the light having passed through the zoom lens 102-1, the focus lens 102-2, the aperture 102-3, and the infrared cut filter 102-4, thereby generating an analog image signal. The generated analog image signal is amplified through a sampling process, such as correlated double sampling, and then provided to the A/D conversion unit 103. The parameter for use in the amplification process is supplied by the CPU 101.

The A/D conversion unit 103 converts the amplified analog image signal into a digital image signal.

The A/D conversion unit 103 outputs the digital image signal obtained by the conversion to the image processing unit 105.

The image input controller 104 takes in the digital image signal provided by the A/D conversion unit 103 and outputs the same to the image processing unit 105.

The image processing unit 105 performs various types of digital image processing on the digital image signal input from the image input controller 104, based on information on sensitivity at the time of image capturing output from the imaging element 102-5. The information on sensitivity at the time of image capturing refers to information on, for example, a gain under automatic gain control (AGC) or sensitivity under International Organization for Standardization (ISO). The image processing unit 105 then stores the processed digital image signal in the RAM 107 via the bus 106. Examples of the various types of digital image processing include optical black processing, pixel defect correction processing, aberration correction, correction of light falloff at edges, gain processing, white balance processing, red-green-blue (RGB) interpolation processing, and dynamic range extension processing. The examples also include color difference signal conversion, offset processing, gamma correction processing, noise reduction processing, contour correction processing, color tone correction processing, light source type determination processing, and scaling processing.

The RAM 107 is a volatile memory, such as a static RAM (SRAM) or a dynamic RAM (DRAM).

The ROM 109 is a non-volatile memory, such as an electrically erasable programmable ROM (EEPROM) or a flash memory.

The storage device 113 is, for example, a hard disk drive (HDD), solid state drive (SSD), or embedded Multi Media Card (eMMC).

The programs for implementing the functions according to the present exemplary embodiment and the data to be used at execution of the programs are stored in the ROM 109 or the storage device 113. These programs and data are taken into the RAM 107 via the bus 106 as appropriate under control of the CPU 101 and executed by the CPU 101 to function as the components according to the present exemplary embodiment.

The I/F 114 includes various I/Fs relating to input and output. The I/F 114 connects to the input device 115 to receive instruction information and notifies the CPU 101 of the reception via the bus 106. Examples of the input device 115 include operation keys such as a release switch and a power switch, arrow key, joy stick, touch panel, keyboard, and pointing device (i.e., mouse). The I/F 114 connects to the display device 116, such as a liquid crystal display (LCD), to display images temporarily stored in the RAM 107, information on operation menus, or the like. The I/F 114 also connects to the network 117 via a local area network (LAN).

The image analysis unit 118 performs image analyses, such as face detection, human detection, moving object detection, passage detection, congestion detection, track detection, and abandon/carrying-away detection. The results of image analyses are notified to the CPU 101 via the bus 106.

The compression/expansion unit 119 performs a compression process on the images to generate compressed data in accordance with a control instruction from the CPU 101 via the bus 106. The compression/expansion unit 119 outputs the generated compressed data to the display device 116 or the network 117 via the I/F 114. The compression/expansion unit 119 performs an expansion process on the compressed data stored in the storage device 113 in a predetermined format to generate non-compressed data. In the compression/expansion process in a predetermined format, still images are compressed and expanded in conformity with JPEG standards, and moving images are compressed and expanded in conformity with standards, such as Joint Photographic Experts Group for Moving Images (MOTION-JPEG), Moving Picture Experts Group 2 (MPEG2), Advanced Video Coding (AVC)/H.264, and AVC/H.265.

The communication unit 120 is controlled by the communication control unit 101-4 to wirelessly communicate with devices based on Z-Wave wireless communication protocol.

The preset control unit 101-3 manages the pan-tilt positions and zoom positions preset by the user, and the cyclical schedules of the preset positions. The preset pan-tilt positions and zoom positions are cycled through by the pan-tilt control unit 101-1 controlling pan-tilt and by the lens control unit 101-2 controlling zoom under instructions from the preset control unit 101-3. The cyclical schedule of the preset pan-tilt positions and zoom positions is an example of information on changes in the imaging range of the imaging apparatus 100.

The communication control unit 101-4 makes settings on sleep mode of devices located in the vicinity of the imaging range such that the devices are returned from the sleep mode before the target pan-tilt position and zoom position are reached. In addition, the communication control unit 101-4 acquires information on devices located in the vicinity of the imaging range at the target pan-tilt position and zoom position before the target pan-tilt position and zoom position are reached.

After the target pan-tilt position and zoom position are reached, the notification unit 101-5 notifies the display device 116 or the like of the information on the devices acquired by the communication control unit 101-4.

The control unit 101-6 identifies the devices located in the vicinity of the imaging range at each preset position and generates sleep schedules of the devices related to each preset position. The control unit 101-6 also performs various controls used in the present exemplary embodiment. The sleep schedules will be described below in detail.

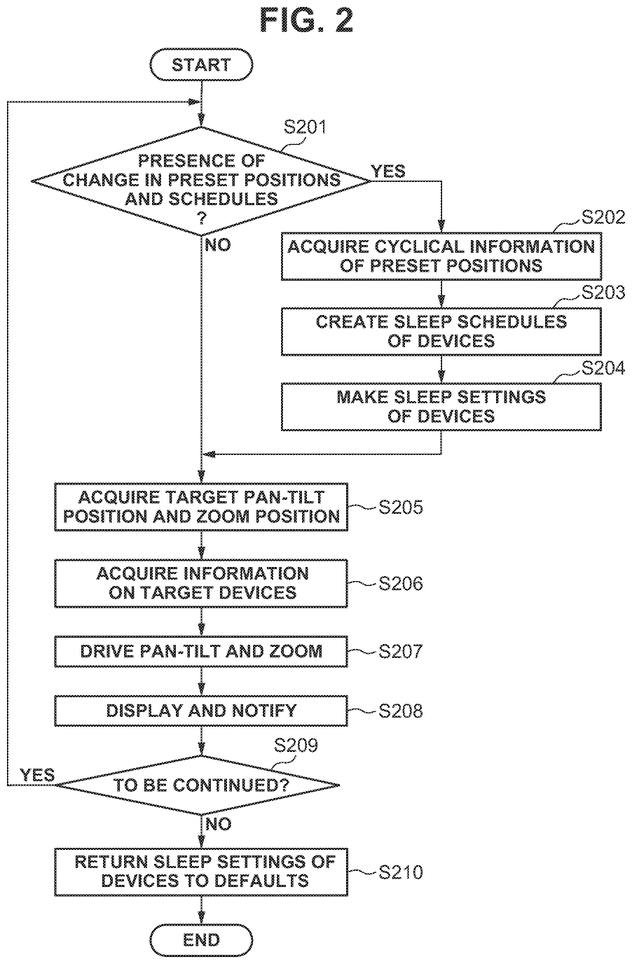

Hereinafter, an example of a processing procedure according to the first exemplary embodiment will be described with reference to the flowchart in FIG. 2. The process in this flow is performed at predetermined intervals.

In step S201, the preset control unit 101-3 determines whether there is a change in at least any of the preset pan-tilt position and zoom position and the cyclical schedule of the preset positions.

If the preset control unit 101-3 determines that there is a change in at least any of the preset pan-tilt position and zoom position and the cyclical schedule of the preset positions (YES in step S201), the processing proceeds to step S202. In contrast, if the preset control unit 101-3 determines that there is no change in any of the preset pan-tilt position and zoom position and the cyclical schedule of the preset positions (NO in step S201), the processing proceeds to step S205.

In step S202, the control unit 101-6 acquires the information on the preset pan-tilt position and zoom position and the information on the cyclical schedule of the preset positions, from the preset control unit 101-3.

In step S203, the control unit 101-6 identifies the devices located in the vicinity of the imaging range at each preset position, based on the information on the preset pan-tilt position and zoom position acquired in step S202. The control unit 101-6 also generates the sleep schedules of the devices relating to each preset position, based on the information on the cyclical schedule of the preset positions acquired in step S202.

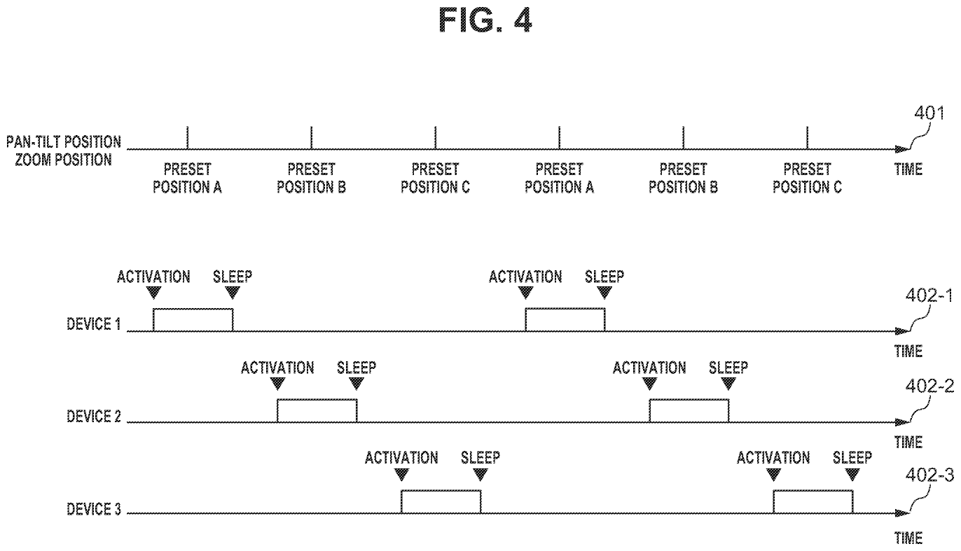

FIG. 4 is a diagram illustrating an example of the cyclical schedule of the preset pan-tilt positions and zoom positions and the sleep schedules of the related devices.

A lapsed time 401 indicates a time lapsed in the cycle through the preset pan-tilt positions and zoom positions. Lapsed times 402-1, 402-2, and 402-3 indicate times lapsed in the activation and sleep of devices 1 to 3 that communicate with the imaging apparatus 100.

The devices 1, 2, and 3 are devices located in the vicinity of the imaging range at preset positions A, B, and C, respectively.

The device 1 is located in the vicinity of the imaging range at the preset position A. Thus, the control unit 101-6 generates a sleep schedule of the device 1 such that the device 1 is activated before the preset position A is reached and is put into a sleep mode after a lapse of predetermined time since the preset position A is reached. The device 2 is located in the vicinity of the imaging range at the preset position B. Thus, the control unit 101-6 generates a sleep schedule of the device 2 such that the device 2 is activated before the preset position B is reached and is put into a sleep mode after a lapse of predetermined time since the preset position B is reached. The device 3 is located in the vicinity of the imaging range at the preset position C. Thus, the control unit 101-6 generates a sleep schedule of the device 3 such that the device 3 is activated before the preset position C is reached and is put into a sleep mode after a lapse of predetermined time since the preset position C is reached.

However, the present exemplary embodiment is not intended to limit the sleep schedules of the devices relating to the preset pan-tilt positions and zoom positions.

In step S204, the communication control unit 101-4 makes settings on sleep mode of the devices based on the sleep schedules of the devices generated in step S203. The settings on sleep mode include settings on timings for the devices to return from a sleep mode and become activated and on timings for the devices to start sleeping.

In step S205, the preset control unit 101-3 acquires information on the next target preset pan-tilt position and zoom position from the cyclical schedule of the preset positions.

In step S206, the control unit 101-6 identifies the devices located in the vicinity of the imaging range at the target preset pan-tilt and zoom positions acquired in step S205. The communication control unit 101-4 acquires information on these devices via the network 117. In this stage, the target devices are returned from a sleep mode in accordance with the settings on sleep mode based on the sleep schedules of the devices set in step S204. Performing this step before the target preset positions are reached makes it possible to provide the information on the devices to the user immediately after the target preset positions are reached. The information acquired from the devices at this time include, but are not limited to, information on the operational status of the devices, and additional information on the devices.

In step S207, the pan-tilt control unit 101-1 controls the pan head 111 via the actuator 112 based on the target pan-tilt position specified by the preset control unit 101-3 to move the imaging unit 102 to the target pan-tilt position. The lens control unit 101-2 also controls the drive unit 108 based on the target zoom position specified by the preset control unit 101-3 to drive the zoom lens 102-1 to move the imaging unit 102 to the target zoom position.

In step S208, the notification unit 101-5 displays or notifies the information on the devices acquired in step S206, on the display device 116 via the I/F 114 or on an external device via the network 117. For example, if the devices are seen in the video image obtained via the imaging element 102-5, the notification unit 101-5 displays the information on the devices acquired in step S206 in association with the video image.

In step S209, the preset control unit 101-3 determines whether to continue to cycle through the preset pan-tilt and zoom positions. If the preset control unit 101-3 determines cycling as to be continued (YES in step S209), the processing returns to step S201. In contrast, if the preset control unit 101-3 determines cycling as not to be continued (NO in step S209), the process is terminated.

In step S210, the communication control unit 101-4 sets sleep periods of the devices to predetermined values, and terminates the process. The predetermined values are, for example, default values.

As described above, according to the present exemplary embodiment, based on the cyclical schedule of the preset pan-tilt positions and zoom positions, the sleep periods of the devices located in the vicinity of the imaging range at the target pan-tilt positions and zoom positions are optimized. In addition, before the target pan-tilt position and zoom position are reached, the devices located in the vicinity of the imaging range at the target pan-tilt position and zoom position are returned from a sleep mode and the information on the devices is acquired. This makes it possible to provide the information on the devices to the user immediately after the target pan-tilt position and zoom position are reached.

In the first exemplary embodiment, the process based on the cyclical schedule of the preset pan-tilt positions and zoom positions of the imaging apparatus 100 is performed.

In relation to a second exemplary embodiment, described is an example where, if an imaging apparatus 100 is instructed to change the pan-tilt position and zoom position, the imaging apparatus 100 calculates a predicted imaging range and shortens the sleep periods of devices located in the predicted imaging range. Also described is a control method by which to, based on the instructed target pan-tilt position and zoom position, return the devices located in the vicinity of the imaging range at the target pan-tilt position and zoom position from a sleep mode and acquire information on the devices.

Hereinafter, an internal configuration example of an imaging apparatus according to the present exemplary embodiment will be described with reference to FIG. 1. Duplicated description of components identical to those in the first exemplary embodiment will be omitted, and only differences from the first exemplary embodiment will be described.

A pan-tilt control unit 101-1 controls pan and tilt to reach the pan-tilt position specified by the user. A lens control unit 101-2 controls zoom to reach the zoom position specified by the user.

A control unit 101-6 predicts the movement of pan-tilt and zoom based on the information from the pan-tilt control unit 101-1 and the lens control unit 101-2. The communication control unit 101-4 cancels or shortens the sleep periods of devices located in the predicted imaging range based on the movement prediction information. The communication control unit 101-4 also acquires information on the devices located in the vicinity of the imaging range at the target pan-tilt position and zoom position.

After the target pan-tilt position and zoom position are reached, a notification unit 101-5 notifies a display device 116 or the like of the information on the devices acquired by the communication control unit 101-4.

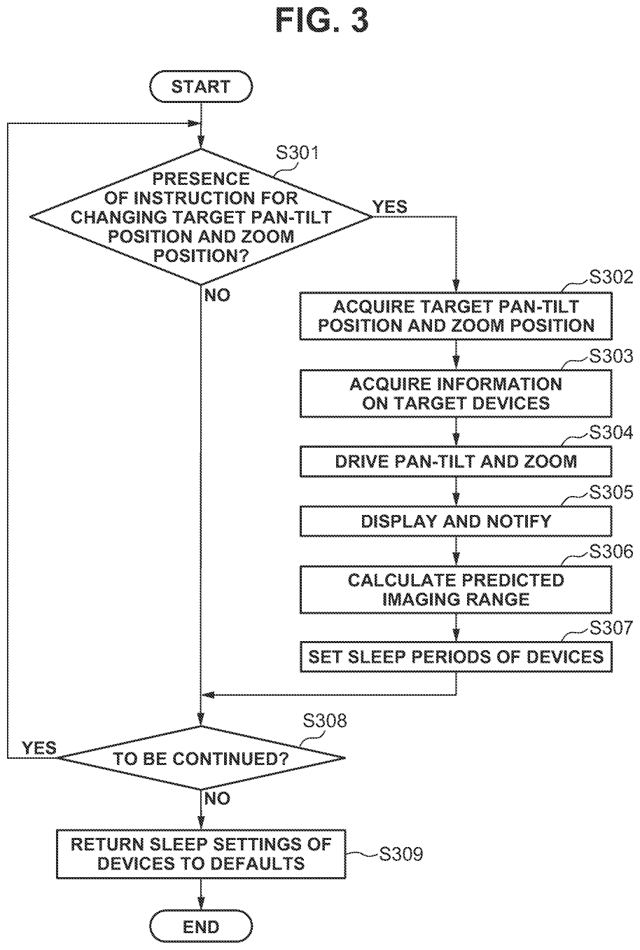

Hereinafter, an example of a processing procedure according to the second exemplary embodiment will be described with reference to the flowchart of FIG. 3. The process in the processing flow is performed at predetermined intervals. Description of the steps similar to those in the first exemplary embodiment will be omitted.

In step S301, the control unit 101-6 determines whether an instruction for changing at least any of the target pan-tilt position and the target zoom position has been received via an I/F 114.

If the control unit 101-6 determines that an instruction for changing at least any of the target pan-tilt position and the target zoom position has been received (YES in step S301), the processing proceeds to step S302. If the control unit 101-6 determines that no instruction for changing at least any of the target pan-tilt position and the target zoom position has been received (NO in step S301), the processing proceeds to step S308.

In step S302, the pan-tilt control unit 101-1 acquires information on the target pan-tilt position from the control unit 101-6, and the lens control unit 101-2 acquires information on the target zoom position from the control unit 101-6.

In step S303, the control unit 101-6 and the communication control unit 101-4 perform processing similar to that performed in step S206 in the first exemplary embodiment.

In step S304, the pan-tilt control unit 101-1 and the lens control unit 101-2 perform processing similar to that in step S207 in the first exemplary embodiment.

In step S305, the notification unit 101-5 performs processing similar to that performed in step S208 in the first exemplary embodiment.

In step S306, the control unit 101-6 calculates the amounts of changes in the pan-tilt position and zoom position in step S304. The control unit 101-6 then predicts the pan-tilt position and the zoom position to which the imaging unit will possibly move in the future, based on the past pan-tilt positions and zoom positions and the calculated amount of change in the pan-tilt position and zoom position. The control unit 101-6 further calculates a predicted imaging range where image capturing will be possibly performed in the future, based on the predicted pan-tilt position and zoom position.

The predicted imaging range is not limited to the one obtained by calculation as described above. For example, taking prediction error into account, a range larger than the imaging range at the pan-tilt position and zoom position in step S304 may be set as predicted imaging range.

In step S307, the communication control unit 101-4 makes sleep settings of the devices located in the vicinity of the predicted imaging range calculated in step S306 so as to shorten the sleep periods of the devices. The communication control unit 101-4 also makes sleep settings of devices other than the devices located in the vicinity of the predicted imaging range such that the sleep periods of the other devices meet predetermined values. The predetermined values are, for example, default values.

The communication control unit 101-4 may deactivate the sleep functions of the devices located in the vicinity of the predicted imaging range calculated in step S306.

In step S308, the control unit 101-6 determines whether an instruction for changing at least any of the target pan-tilt position and the target zoom position has been received within a predetermined period. If the control unit 101-6 determines that an instruction for changing at least any of the target pan-tilt position and the target zoom position has been received within a predetermined period or that the predetermined period has not yet been elapsed (YES in step S308), the processing returns to step S301 to continue the process in this processing flow. In contrast, if the control unit 101-6 determines that no instruction for changing at least any of the target pan-tilt position and the target zoom position has been received within a predetermined period (NO in step S308), the processing proceeds to step S309.

In step S309, the communication control unit 101-4 performs processing similar to that performed in step S210 in the first exemplary embodiment.

As described above, according to the imaging apparatus in the present exemplary embodiment, it is possible to optimize the sleep periods of the devices located in the vicinity of the predicted imaging range, based on the target pan-tilt position and zoom position specified by the user. Then, by acquiring the information on the devices located in the vicinity of the imaging range at the target pan-tilt position and zoom position, it is possible to provide the information on the devices to the user immediately after the target pan-tilt position and zoom position are reached.

### Other Exemplary Embodiment

In the exemplary embodiments described above, the imaging apparatus having the imaging unit is taken as an example. In the case of applying the present disclosure to a network camera, such as a monitoring camera, a monitoring camera having an imaging unit may be controlled in pan, tilt, and zoom in a wireless or wired manner. In this case, the configuration illustrated in FIG. 1 is applied to an information processing apparatus that controls the monitoring camera.

Some embodiments of the present disclosure can also be carried out by supplying a program implementing one or more functions in the foregoing exemplary embodiments to a system or an apparatus via a network or a storage medium, and causing one or more processors in a computer in the system or apparatus to read and execute the program. Some embodiments can also be carried out by a circuit implementing one or more functions (for example, an application specific integrated circuit (ASIC)).

According to the present disclosure, it is possible to quickly provide information on IoT devices having a sleep function, at a desired timing.

### Other Embodiments

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2021-137083, which was filed on Aug. 25, 2021 and which is hereby incorporated by reference herein in its entirety.

What is claimed is:

1. An information processing apparatus communicating with an external device, comprising:
at least one processor causing the information processing apparatus to:
acquire information on a change in an imaging range of an imaging unit;
perform a control to make a setting on a sleep mode of an external device that possibly falls within the imaging range due to the change in the imaging range;
acquire information on the external device, from the external device having returned from the sleep mode in accordance with the setting; and
output the information on the external device.

2. The information processing apparatus according to claim 1, wherein the at least one processor further causes the information processing apparatus to acquire the information on the external device before the external device falls within the imaging range due to the change in the imaging range.

3. The information processing apparatus according to claim 1,
wherein the at least one processor further causes the information processing apparatus to
acquire information relating to a schedule on which the imaging range of the imaging unit changes, and,
based on the schedule, perform a control to set a start time and an end time of the sleep mode of the external device that possibly falls within the imaging range due to the change in the imaging range.

4. The information processing apparatus according to claim 1, wherein the at least one processor further causes the information processing apparatus to
acquire information on a target imaging range, and,
based on the information on the change in the imaging range of the imaging unit and the target imaging range, predict a possible imaging range and perform a control to shorten a sleep period of the external device within the possible imaging range that is predicted.

5. The information processing apparatus according to claim 4, wherein the at least one processor further causes the information processing apparatus to predict the possible imaging range based on an amount of change in the imaging range.

6. The information processing apparatus according to claim 4, wherein the at least one processor further causes the information processing apparatus to predict a range wider than the target imaging range acquired by the first acquisition unit, as the possible imaging range.

7. The information processing apparatus according to claim 1, wherein the at least one processor further causes the information processing apparatus to control the imaging range by controlling pan, tilt, and zoom of the imaging unit.

8. The information processing apparatus according to claim 1, wherein the information processing apparatus is an imaging apparatus having the imaging unit.

9. An information processing method executed by an information processing apparatus communicating with an external device, the method comprising:
acquiring, as a first acquisition, information on a change in an imaging range of an imaging unit;
controlling to make a setting on a sleep mode of the external device that possibly falls within the imaging range due to the change in the imaging range;
acquiring, as a second acquisition, information on the external device, from the external device having returned from the sleep mode in accordance with the setting in the controlling; and
outputting the information acquired in the second acquisition.

10. A computer-readable storage medium recording a program for causing a computer to execute a control method of an information processing apparatus communicating with an external device, the method comprising:
acquiring, as a first acquisition, information on a change in an imaging range of an imaging unit;
performing a control to make a setting on a sleep mode of the external device that possibly falls within the imaging range due to the change in the imaging range;
acquiring, as a second acquisition, information on the external device from the external device having returned from the sleep mode in accordance with the setting in the performing the control; and
outputting the information acquired in the second acquiring.
